(19) United States
(12) Patent Application Publication
(10) Pub. No.: US 2025/0210673 A1
(43) Pub. Date: Jun. 26, 2025

(54) SEPARATOR PLATE FOR AN ELECTROCHEMICAL SYSTEM AND ELECTROCHEMICAL SYSTEM

(71) Applicant: Reinz-Dichtungs-GmbH, Neu-Ulm (DE)

(72) Inventors: Harald REBIEN, Neu-Ulm (DE); Hans WALDVOGEL, Krumbach (DE); Jonas LEISCHER, Neu-Ulm (DE); Stephan WENZEL, Pfaffenhofen (DE); Franz SCHWEIGGART, Pfaffenhofen (DE)

(21) Appl. No.: 18/988,350

(22) Filed: Dec. 19, 2024

(30) Foreign Application Priority Data
Dec. 22, 2023 (DE) 20 2023 107 632.7

(51) Int. Cl. H01M 8/0265; H01M 8/0206; H01M 8/0254; H01M 8/0263

(52) U.S. Cl. CPC H01M 8/0265; H01M 8/0206; H01M 8/0254; H01M 8/0263

(57) ABSTRACT

The present disclosure relates to a separator plate for an electrochemical system, in particular for an electrolyzer, wherein the separator plate has, at least on a first side, a plurality of channels through which flow can pass in a longitudinal direction of the channel and which are each separated from one another, at least in sections, by a web, wherein the channels each have a plurality of regions with reduced flow cross-section, wherein the number of regions with reduced flow cross-section within a first half of a total channel length of each channel is less than within a second half of the total channel length.

### CROSS REFERENCE TO RELATED APPLICATION

This application claims priority to German Utility Model Application No. 20 2023 107 632.7, entitled “SEPARATOR PLATE FOR AN ELECTROCHEMICAL SYSTEM AND ELECTROCHEMICAL SYSTEM”, filed Dec. 22, 2023. The entire contents of the above-identified application is hereby incorporated by reference for all purposes.

### TECHNICAL FIELD

The present disclosure relates to a separator plate for an electrochemical system and an electrochemical system, wherein the electrochemical system is in particular an electrolyzer.

### BACKGROUND AND SUMMARY

The use of electrochemical systems, and in particular electrolyzers, is prior art. A known basic principle of an electrolyzer structure is discussed below with reference to the FIG. 1 disclosed here.

However, it was found that it is not always possible to achieve the desired level of efficiency with known electrochemical systems.

The present disclosure is therefore directed to the object of improving the efficiency of an electrochemical system.

This object is at least partially solved by the subject-matter disclosed herein.

Accordingly, a separator plate is proposed for an electrochemical system, in particular for an electrolyzer, wherein the separator plate has, on at least a first side, a plurality of channels through which flow can pass in a longitudinal direction of the channel, that is in a through-flow direction, and which are each separated from one another at least in sections by a web, wherein the channels each have a plurality of regions with reduced flow cross-section, wherein the number of reduced flow cross-section regions within a first half of a total channel length of each channel is less than within a second half of the total channel length.

According to the present disclosure, it was recognized that the efficiency of existing electrochemical systems can be impaired in particular by the fact that generated reaction products accumulate in regions, with the consequence that these regions are no longer sufficiently accessible for the desired electrochemical reaction to take place. In particular, downstream reaction media can no longer reach these regions, or can reach them only to a limited extent, so that the desired electrochemical reaction is not realized to the desired extent. This is particularly critical if the regions include catalyst materials for implementing the electrochemical reaction.

In the case of electrolyzers, it was recognized that in particular catalyst layers in the region of an anode of an electrochemical cell can be covered by oxygen produced during the electrochemical reaction. Since water is typically used as the reaction medium along the anode, the oxygen concentration along the flow path increases and the achievable local efficiency therefore decreases. The more oxygen is produced or, in other words, the higher the gas content, the more difficult it becomes for the supplied water to remove the oxygen. It is also more difficult for the water to penetrate a typically porous transport layer on its way to the anode or the catalyst layer there. The increasing gas content also impairs the local viscosity of the water/oxygen mixture and thus its local flow behavior.

The present disclosure therefore proposes structural adaptations to separator plates, by means of which such disadvantages can be at least partially reduced. In particular, it is proposed to achieve local increases in the flow rate of a reaction medium that is guided along the surface of the separator plate, by means of the regions with reduced flow cross-section. This can increase the likelihood of reaction products being sufficiently removed or, in other words, washed away.

The fact that the regions with reduced flow cross-section are unevenly distributed along the total length of the channel means that the concentration of reaction products to be removed increases as expected in a flow direction along the longitudinal axis of the channel. If the reaction medium flows along the separator plate from the first half towards the second half, the higher number of regions with a reduced flow cross-section in the second half means that the reaction products that are expected to be present there can be reliably removed and/or a catalyst layer can still be reached past the reaction products.

The channels can each be surrounded by a flow region of the separator plate, within which at least one reaction medium can flow. The flow region can comprise a known distribution field and a known flow field. The flow field can be the region that is at least partially or even largely opposite, or is covered by, a GDL and/or PTL described below. In other words, the flow field can be located in an electrochemically active region of the electrochemical system, that is of an electrochemical cell that is surrounded by it. A distribution field, on the other hand, can be used to feed the reaction medium into the flow field and/or transport the reaction medium out of the flow field. There is typically no electrochemical reaction within the distribution field.

The reduced flow cross-section regions disclosed here can optionally be provided exclusively in the distribution field or, for example, can be provided in a larger number in the distribution field than in the flow region. This can take into account the fact that reaction products that may hinder the electrochemical reaction are expected to be predominantly present in the distribution field, that is, will accumulate there.

The channels can generally be elongated. For example, a length can exceed a width of the channels by a factor of at least twenty or at least fifty. The channels can be, but do not have to be, straight. For example, they can also be wavy and/or curved one or more times and/or angled one or more times. An embodiment with a meandering channel is explained below.

The webs and channels can each be produced by a stamping process of a base body, for example, a metallic one. Optionally, the webs and channels can be directly adjacent to each other and/or merge into each other. Optionally, a large number of channels and webs positioned between them are provided, for example at least 20 or at least 100 channels. The webs may separate the channels from each other along their entire length and/or may extend between the channels along their entire length. However, an at least local fluid-conducting connection across the webs can be provided by means of optional channel-connecting regions as explained below. In this case, the webs can be understood, for example, as structurally and/or spatially separating the channels, but connecting them locally in a fluid-conducting manner.

The channels can connect through-openings within the separator plate. For example, they can extend between two through-openings and connect them to each other in a fluid-conducting manner. In a manner known per se, a reaction medium can be guided through a through-opening, which reaction medium can pass into the channels and be guided by these in the direction of the corresponding other through-opening.

The regions with reduced flow cross-section can be formed integrally with the separator plate or, in other words, incorporated in one piece into the material of the separator plate. They can be molded directly into a respective channel and/or merge directly into at least one channel side wall and/or a channel bottom. The channel bottom, which can also be referred to as the channel floor, can be the deepest region of a channel. It can be connected to an outer surface and/or an adjacent outermost or uppermost region of the first side of the separator plate via channel side walls. Such an outermost or uppermost region can be formed by a web or can be surrounded by the web. The channel side walls can connect to the channel bottom on both sides, e.g. with respect to a cross-sectional view, wherein the cross-sectional plane can be orthogonal to the longitudinal direction of the channel. Any channel side wall can generally run along the longitudinal direction of the channel.

The channel side walls can be aligned vertically or essentially vertically to the surface plane of the separator plate. For example, the channel bottom is aligned parallel to or essentially parallel to the surface plane of the separator plate. The wording “essentially” can include, for example, deviations from parallelism or orthogonality of up to 30°, up to 20°, up to 10° or up to 5°. The channel side walls can generally delimit the channel with respect to the flow plate. In the case of very small channel geometries, the side walls can also transition from the channel bottom to the web via two curved lines without including any straight sections. In this case, the channel side wall can be the part that connects the channel bottom and the web.

The regions with reduced flow cross-section can span an entire channel width and/or extend between opposite channel side walls and connect them to each other. Optionally, they can have a pronounced transverse extension in relation to a longitudinal channel axis. Consequently, the regions with reduced flow cross-section can also be referred to as transverse ribs within a channel or can form such transverse ribs.

According to a further embodiment, the first half of the total channel length is upstream of the second half. Consequently, the smaller number of regions with reduced flow cross-section is also upstream, i.e. the number of regions with reduced flow cross-section increases in the direction of flow. The term upstream refers to the direction of flow along the length of the channel. In principle, this flow direction can be considered independently of a spatial orientation. For example, this flow direction can also be vertical with a correspondingly upright orientation of the separator plate.

In this embodiment, a predetermined flow direction along the channels is assumed. This can relate to a flow direction from a first through-opening in the direction of a second through-opening, wherein these through-openings are connected in a fluid-conducting manner by the channels.

According to one embodiment, the number of regions with reduced flow cross-section within the second half of the total channel length is at least 10% higher than the number within the first half of the total channel length and may be at least 20% higher, at least 35% higher or at least twice as high. It has been shown that this effectively compensates for the influence of the increasing oxygen concentration in a flow from the first to the second half.

Additionally or alternatively, the number of regions with reduced flow cross-section within the second half of the total channel length may be no more than four times higher or no more than five times higher than within the first half of the total channel length (in particular of a respective channel). This limits the flow resistance generated by the regions with reduced flow cross-section within the second half, which in turn prevents impairments in efficiency.

According to one embodiment, the number of regions with reduced flow cross-section within the first half and/or the second half of the total channel length is at least 5 and may be at least 10. This can effectively limit impairments to efficiency.

According to one embodiment, at least within the second half of the total channel length, the separation distance between successive regions with reduced flow cross-section (in particular of a respective channel) is inhomogeneous. This takes into account the fact that, as expected, the oxygen concentration is not constant, particularly within this second half, so that the separation distances can be adjusted accordingly.

For example, the separation distance can decrease, at least in sections, with respect to the longitudinal direction of the channel. The separation distance should be measured from the start of a first region with a reduced flow cross-section to the start of a subsequent region with a reduced flow cross-section. The beginning should be the point at which the flow cross-section is reduced by narrowing the channel. Thus, with decreasing separation distance within the second half of the total channel length, the concentration or frequency of the regions with reduced flow cross-section can increase, at least in sections, especially with respect to a flow direction. This in turn takes account of the fact that the oxygen concentration increases as expected within the second half and also in the direction of flow. From the end of a reduced flow region to the beginning of the next reduced flow region, the full width of the channel should optionally be available again, at least over the length of a reduced flow region.

According to one embodiment, at least some of the positions of the reduced flow cross-section regions of a respective channel deviate from the positions of the reduced flow cross-section regions of at least one other channel with respect to the total length of the channel. This can apply to channels that are directly adjacent to each other. This allows a local pressure difference to build up between the channels. For example, the pressure can be increased in a first channel at the position of its reduced flow cross-section region, whereas in the other channel at the same position the pressure remains constant and is lower in comparison. This can favor a fluid flow from the first channel into the other channel. In other words, a cross-flow can be generated between the channels, for example, by overcoming a web between these channels. This increases the ability to remove accumulated oxygen and, in particular, to flush a PTL (explained below) free of oxygen.

According to one embodiment, the reduced flow cross-section regions define a flow cross-section reduction primarily in a height direction of a respective channel. A channel width, on the other hand, can optionally be constant or at least decrease to a lesser extent than the height of the channel. Such a design of the regions with reduced flow cross-section is favorable in terms of production technology.

The height direction can extend perpendicular to a surface plane of the separator plate and/or a middle or base plane thereof. The surface plane can contain those regions of the separator plate that are not deformed during an embossing process, for example. The width of a respective channel can extend perpendicular to the height direction as well as perpendicular to the longitudinal axis of the channel.

According to one embodiment, the regions with reduced flow cross-section have a first section with increasing height and a second section with decreasing height with respect to the longitudinal direction of the channel. The first section may be located upstream of the second section and points, for example, in the direction of a channel end within the first half, whereas the second section can point in the direction of a channel end within the second half. Additionally or alternatively, the first section is optionally longer than the second section. In other words, the regions with reduced flow cross-section can be asymmetrical with respect to their respective center planes, which are orthogonal to a longitudinal channel axis.

In this embodiment, the height increase can be less steep than the height decrease. This favors an overflow of the region with reduced flow cross-section with limited flow turbulence. As a result of the reduced length of the second section, the size of the regions with reduced flow cross-section can be reduced, which can be advantageous in terms of production technology.

The first section can be curved or flat, but can also be slanted or inclined. This also helps to limit flow turbulence.

The following comments on the first and second sections and their length ratios and in particular their measurement as projected lengths also apply accordingly in the present context.

In general, the regions of a separator plate with reduced flow cross-section, for example in a width direction thereof, and/or of an individual channel, can be of the same design or can differ from one another. For example, the width direction can extend orthogonally to the longitudinal direction of the channel and/or can correspond to a shorter dimension of a generally rectangular separator plate. In the latter case, the differences can be designed in such a way that they take into account the increasing concentration of oxygen along a flow direction. For example, as the local oxygen concentration increases, the regions with reduced flow cross-section can be designed in such a way that they reduce the flow cross-section to a correspondingly increasing extent and consequently increase the local water pressure, for example compared to regions with reduced flow cross-section located downstream.

According to one embodiment, at least some of the regions with reduced flow cross-section extend between a first channel side wall and a second channel side wall and rise, at least in sections, towards one of the first and second channel side walls. The channel side walls can extend along the longitudinal axis of the channel and can run at the same distance from and/or parallel to it. They can be connected by a channel bottom. This channel bottom can, for example, run parallel to a surface plane of the separator plate and/or comprise the lowest point of the channel with respect to the vertical direction.

In other words, the height of the regions with reduced flow cross-section at a transition to the first channel side wall can be different from the height at a transition to the second channel side wall. With respect to a cross-section in which the cross-sectional plane runs perpendicular to the longitudinal axis of the channel, an outward and/or upward-facing surface of the regions with reduced flow cross-section can be angled and/or slanted accordingly.

This height increase and/or inclined course of the regions with reduced flow cross-section can in turn promote cross-flow between neighboring channels.

According to one embodiment, at least some of the webs have at least one channel-connecting region. The channel-connecting region can also be referred to as the channels-connecting region. It can connect the two channels, which are separated from each other by the web that they are adjacent to, in a fluid-conducting manner. This means that a fluid carried in a first channel can enter a second channel via the channel-connecting region and/or vice versa. The first and second channels may be separated from each other outside the channel-connecting region (or the channel-connecting regions) by the web. The channel-connecting region in turn promotes cross-flow between neighboring channels, which is advantageous for effective removal of the generated oxygen.

However, a channel-connecting region can also extend between different sections of the same channel. This applies in particular to channels that do not extend exclusively in a straight line. In this case, a neighboring web can not only extend in a straight line, but can also be adapted to the extension of one or both neighboring channels, for example. This can result in at least one section of a web being arranged between two adjacent channel sections of one and the same channel. One example is a multiply-curved and/or angled and/or meandering channel and web course, as explained below using an example embodiment. In such cases, the channel-connecting region can, for example, be formed in the web section that is arranged between two neighboring channel sections and, for example, establish a fluid connection between the neighboring channel sections that crosses this web section.

The channel-connecting regions can each extend adjacent to, or at a short distance from, a region with a reduced flow cross-section. The distance is with respect to a longitudinal axis of the channel. For example, it can be less than 5 cm and optionally less than 2 cm. The region with reduced flow cross-section can be formed in one of the channels or channel sections connected by the channel-connecting region. If the channel-connecting region is formed with a first and second section of the type explained above, for example, in a section with a greater length, the channel-connecting region may be positioned closer to the first section than to the second section. Optionally, at least in sections it can be positioned at the same position as the first section with respect to the longitudinal axis. This allows the pressure increase generated by the first section to be efficiently converted into a cross-flow along the channel-connecting region.

In general, the channel-connecting region can form a local depression within a web, which may run at an angle to a longitudinal web axis and/or over the entire width of the web. However, the depression may remain above the adjacent channel bottoms.

Optionally, the channel-connecting region may have a first mouth region, in which it opens into a first of the channels or channel sections separated by the web, and a second mouth region, in which it opens into a second of the channels or channel sections separated by the web. The mouth regions can be lowered in relation to a web roof and/or a generally highest height level of the web, for example in the direction of the channels into which they open. For example, the mouth regions can be at least halfway up the height of channel. This enables fluid to be introduced and discharged with low resistance in the channel-connecting regions.

Optionally, the first and second mouth regions can be at different heights. Consequently, the channel-connecting region can have a gradient. Optionally, it can be beveled and/or angled and/or have a sloping curvature between the mouth regions. This promotes flow through the neighboring component (e.g. the PTL).

According to one embodiment, the regions with reduced flow cross-sections are arranged in such a way that the hydrogen produced there can flow across the rear side of a single-layer separator plate.

According to one embodiment, the separator plate is made of titanium or comprises titanium. Alternatively or additionally, the separator plate can have a material thickness of at least 0.2 mm. Alternatively or additionally, the separator plate can have a plurality of through-openings on both sides of a flow field that comprises at least sections of the channels, each of which is connected to the flow field in a fluid-conducting manner.

A separator plate with any of the above features is particularly suitable for use in electrochemical systems and especially in an electrolyzer.

The present disclosure also relates to a separator plate for an electrochemical system, in particular for an electrolyzer, the separator plate having, on at least a first side, a plurality of channels through which flow can pass in a longitudinal channel direction and which are each separated from one another by a web, the channels each having a plurality of reduced flow cross-section regions, the reduced flow cross-section regions having a first section with an increasing height and a second section with a decreasing height, the first section lying upstream of the second section and having a greater length than the second section. The first and second sections can be separated from each other by a further section, for example a section with a constant height.

Optionally, a respective length of the first section and the second section is with respect to a surface plane of the separator plate. This can correspond to a projected length, for example as a result of an orthogonal projection of the respective section length onto a common plane and for example onto the surface plane. This also applies in the context of the previously discussed aspect and its analogous embodiment comprising first and second sections of the type described.

This separator plate can have all the other embodiments and variants mentioned here, which are disclosed, for example, in connection with the separator plate explained above.

The present disclosure also relates to a separator plate for an electrochemical system, in particular for an electrolyzer, the separator plate having, on at least a first side, a plurality of channels through which flow can pass in a longitudinal channel direction and which are each separated from one another by a web, the channels each having a plurality of reduced flow cross-section regions, at least some of the reduced flow cross-section regions extending between a first channel side wall and a second channel side wall and rising, at least in sections, towards one of the first and second channel side walls.

This separator plate can also have all the other embodiments and variants mentioned here, which are disclosed, for example, in connection with the separator plate described first.

The present disclosure also relates to a separator plate for an electrolyzer, the separator plate having, on at least a first side, a plurality of channels through which flow can pass in a longitudinal direction of the channel and which are each separated from one another by a web, the channels each having a plurality of regions of reduced flow cross-section, at least some of the webs having at least one channel-connecting region and the channel-connecting region having a first mouth region in which it opens into a first of the first channels separated by the web, and a second mouth region, in which it opens into a second of the first channels by from the web.

This separator plate can also have all the other embodiments and variants mentioned here, which are disclosed, for example, in connection with the separator plate described first.

Finally, the present disclosure also relates to an electrochemical system, in particular an electrolyzer, comprising a plurality of separator plates, each formed according to any of the aspects disclosed herein.

Optionally, a separator plate can be installed in a single layer. In such a case, both outer sides or even surfaces of the separator plate can be part of an electrochemical cell and/or carry reaction media for the electrochemical reaction. This enables a compact structure, especially in comparison to a two-layer design, in which the inner sides of the two layers facing each other are not directly involved in the electrochemical reaction and, in particular, do not carry any of the involved reaction media.

Exemplary embodiments of the present disclosure will be explained below with reference to the accompanying schematic figures. Similar features, or features having the same effect, can be provided with the same reference signs across all figures. Within a particular figure, not all instances of an illustrated feature are provided with the reference symbol assigned to this feature.

### BRIEF DESCRIPTION OF THE FIGURES

FIG. 1 shows the basic structure of an electrochemical system in the form of an electrolyzer according to an embodiment of the present disclosure.

FIG. 2 shows a separator plate according to an embodiment of the present disclosure, such as can be used in the system shown in FIG. 1, but without a representation of regions with reduced flow cross-section.

FIGS. 3A-C show possible distributions of regions with reduced flow cross-sections within a separator plate, such as the separator plate in FIG. 2.

FIGS. 4-8 show possible embodiments of regions with reduced flow cross-sections, as they can be formed in a separator plate from FIG. 2, for example.

FIGS. 9-10 show possible pressure distributions that can be generated by regions with reduced flow cross-sections, for example in the separator plate shown in FIG. 2.

FIGS. 11A and 12A are partial views of a separator plate as shown in FIG. 2, for example, in order to explain the characteristics and functions of regions with reduced flow cross-sections.

FIGS. 11B and 12B show variants of the embodiments shown in FIGS. 11A & 12A.

FIG. 13 shows a separator plate according to a further embodiment of the present disclosure.

### DETAILED DESCRIPTION

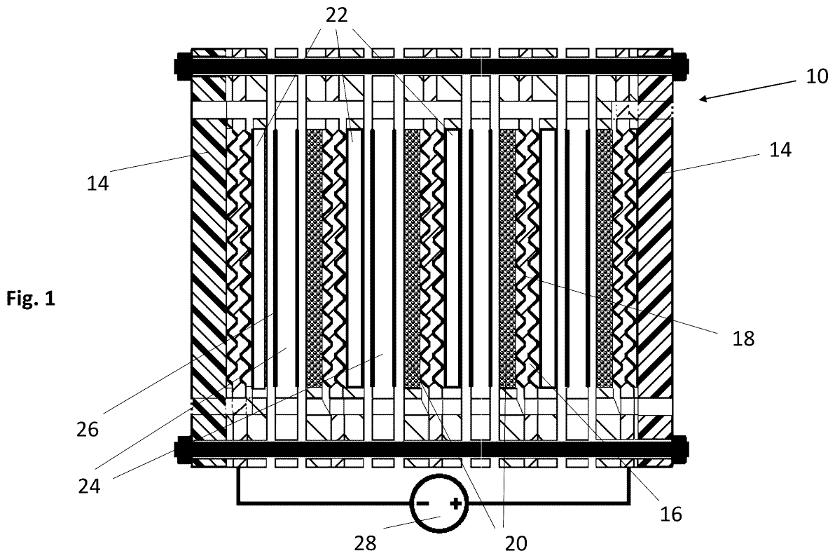

FIG. 1 shows an electrochemical system 10 according to an embodiment of the present disclosure. The electrochemical system 10 is an electrolyzer. The basic structure of this electrolyzer explained here is known in principle. Modifications according to the present disclosure disclosed herein relate in particular to the design of the separator plate 18.

The electrolyzer comprises a stack of repeating component sequences as explained below. The stack is arranged and clamped between two boundary plates 14.

Bipolar plates 16 are provided within the stack, which each consist of a single layer separator plate 18. The separator plate 18 is formed from a single metal sheet and may be embossed and/or stamped. In FIG. 1, the waveform of the separator plate 18 is merely intended to indicate the embossed structure of the channels without the waveform representing a direction of the channels.

The separator plate 18 has outer surfaces that face away from each other. These surfaces each form an anode side or a cathode side of the bipolar plate 16. More precisely, a first outer surface of the separator plate 18 is opposite a porous transport layer (PTL) 20 and may lie against it. The PTL 20 comprises or consists of titanium or a titanium alloy in the form of a porous material, for example a sintered material. The corresponding surface or side of the separator plate 18 forms an anode side of the bipolar plate 16.

The corresponding other outer surface of the separator plate 18 of each bipolar plate 16 is opposite a gas diffusion layer (GDL) 22 and may lie against it. The GDL 22 comprises or consists of carbon and may be a carbon fleece. The corresponding surface or side of the separator plate 18 forms a cathode side of the bipolar plate 16.

A catalyst carrier 24 is arranged between a PTL 20 and an adjacent GDL 22, which is coated with catalyst materials, see a catalyst layer 26 marked as an example in FIG. 1.

During operation of the electrolyzer, water is guided along the anode side of the bipolar plate 16. In FIG. 1, the direction of flow of the water can, for example, be vertically upwards or vertically downwards (or vice versa) or from right to left (or vice versa).

The water is split into oxygen, electrons and positively charged hydrogen ions by interacting with an adjacent catalyst layer 26 and through the application of a voltage using a voltage source 28. The hydrogen ions diffuse to the cathode side, where they combine with the electrons to form hydrogen. In order to reach the catalyst layer 26, the water must penetrate an adjacent PTL 20.

The oxygen concentration increases along the direction of flow of the water as it flows along a separator plate 16. As a result, the water is increasingly prevented from penetrating the PTL 20 and thus from reaching the catalyst layer 26. This reduces the overall achievable efficiency of the electrolyzer.

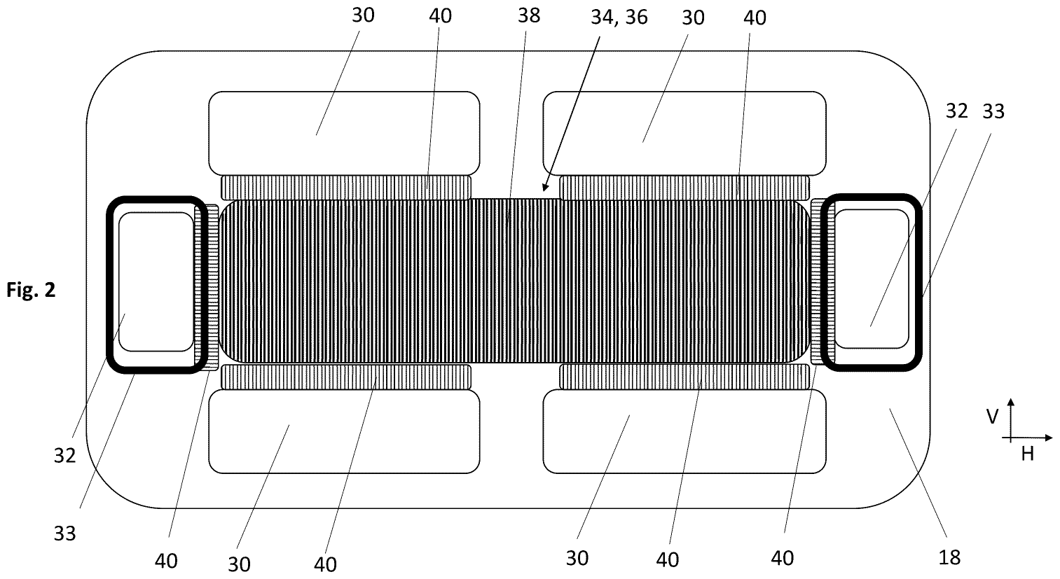

FIG. 2 shows a single separator plate 18 as it can be used in the system 10 of FIG. 1. In FIG. 2, one anode side of the separator plate 18 is facing the viewer. The separator plate 18 comprises a plurality of through-openings 30, 32. More precisely, two hydrogen through-openings 32 are provided, but each is surrounded by a seal 33. The seal 33 prevents a fluid-conducting connection of the hydrogen through-openings 32 to the illustrated anode side of the separator plate 18.

Furthermore, four water through-openings 30 are provided as an example. These are not sealed off from the anode side shown and are therefore connected to it in a fluid-conducting manner.

The anode side is also embossed with a channel-web arrangement, which forms a flow region for the water supplied via the water through-openings 30.

The channel-web arrangement comprises a plurality of channels 34 and webs 36 that extend between the channels and separate them, for example spatially and/or structurally. An extension direction and thus also a respective longitudinal axis of the channels 34 and webs 36, which is not shown separately, runs vertically in FIG. 2, see the illustrated coordinate system having a vertical axis V and a horizontal axis H. Consequently, the channels 34 and webs 36 each extend between two opposing water through-openings 30.

The flow region is divided into a flow field 38, which is located in an electrochemically active region of the system 10 and in which the conducted water participates in the electrochemical reaction of the electrolyzer. Furthermore, the flow region includes distribution regions 40 in which no electrochemical reaction takes place. These distribution regions 40 are each assigned to one of the through-openings 30, 32 in order to connect the through-openings to the flow field 38 in a fluid-conducting manner.

In a manner known per se, the channels 34 and webs 36 on the cathode side of the separator plate 18 that faces away from the observer form a complementary channel/web arrangement. On this cathode side, the water through-openings 30 are fluidically sealed by seals 33 and the hydrogen through-openings 32 are fluidically connected to the flow region.

The structure of the separator plate 18 discussed above essentially corresponds to conventional examples of the prior art. However, the solution disclosed here provides for modifications in the form of the reduced flow cross-section regions 42, which are not shown separately in FIG. 2 and which are explained below.

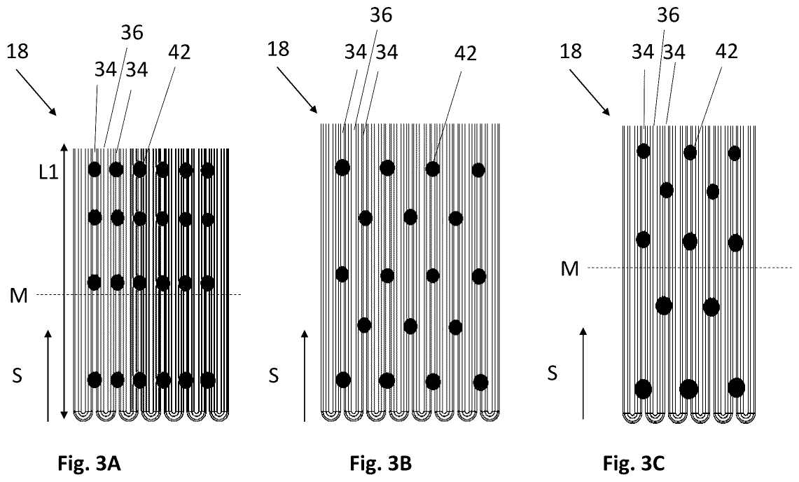

With reference to FIGS. 3A-C, the positions of the regions with reduced flow cross-section 42 are first explained. FIGS. 3A-C each show sections of the flow region of the separator plate 18 of FIG. 1 and in particular of its flow field 38. Once again, the anode side of the separator plate 18 is considered. The longitudinal axes of the channels 34 and webs 36 again run vertically. A selected arrangement of two channels 34 and a web 36 extending between them is marked with a corresponding sequence of reference signs. A flow direction S of the water runs vertically between two of the water through-openings 30 not shown separately in these figures.

The regions with reduced flow cross-section 42 are indicated as dots and only selected ones of these regions are marked with a corresponding reference symbol.

In the case of FIG. 3A, it is shown that the density of the reduced flow cross-section regions 42 increases along a respective channel 34 in the flow direction S. More precisely, a distance between two directly adjacent regions with a reduced flow cross-section 42, with respect to the longitudinal direction of the channel, decreases along the direction of flow S. This takes into account the fact that an oxygen concentration increases when viewed in the direction of flow S.

FIG. 3A also schematically indicates the position of a center axis M, which intersects the channels 34 at half their length. It can be seen that within a first lower half of the channels 34, i.e. along a first half of the total channel length L1, fewer regions with reduced flow cross-section 42 are provided than in the upper half. The lower half is upstream of the upper half.

FIG. 3A also shows an optional variant in which the reduced flow cross-section regions 42 of neighboring channels 34 are each positioned at the same positions with respect to a longitudinal direction of the channel.

FIG. 3B shows a variant in which the reduced flow cross-section regions 42 of neighboring channels 34 are not each positioned at the same positions with respect to a longitudinal direction of the channel. This can favor cross-flows between the channels 34, since the reduced flow cross-section regions 42 can generate a significant pressure difference compared to a neighboring channel that does not have a reduced flow cross-section region 42 at the same longitudinal position. The distances along the longitudinal axis of each channel between the individual regions with reduced flow cross-sections are the same.

FIG. 3C shows a variant in which the embodiments of FIGS. 3A and 3B are combined. Thus, the number of reduced flow cross-section regions 42 increases along a respective longitudinal axis of a channel and, in particular, in a second downstream half of a total channel length L1, although the positions of the reduced flow cross-section regions 42 are offset along the longitudinal axis relative to a respective adjacent channel 34. This variant combines the advantages of the variants in FIGS. 3A and 3B.

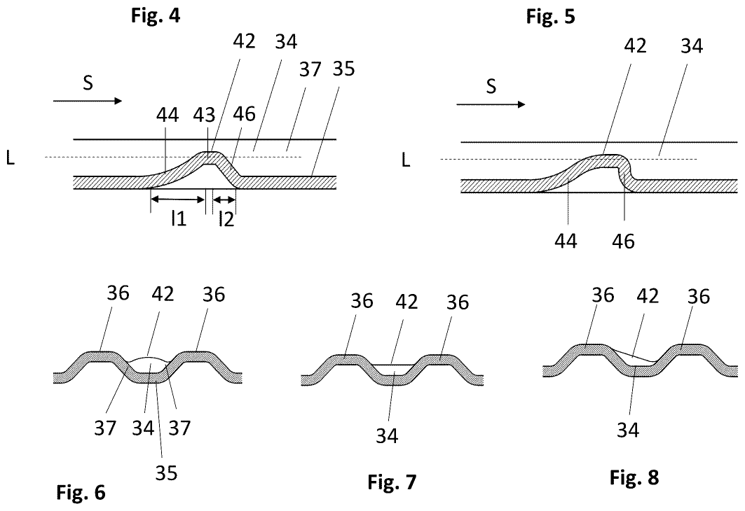

FIG. 4 shows a partial sectional view through a single channel 34, with a region with a reduced flow cross-section 42 lying in the sectional plane. The sectional plane also contains a longitudinal channel axis L. A flow direction S is also indicated, which is essentially parallel to the longitudinal axis L of the channel. In addition, a channel bottom 35 and a channel side wall 37 are marked in FIG. 4.

A channel length extends along the longitudinal axis L. A channel width runs orthogonally to this and orthogonally to the image plane of FIG. 4. In FIG. 4, a channel height extends perpendicular to the channel bottom.

The region with reduced flow cross-section 42 has a first section 44 and a second section 46, wherein, with respect to the direction of flow, the first section 44 is located upstream of the second section 46 and the sections 44, 46 are connected via a comparatively shorter section 43 that has a constant height. In the example shown, the second section 44 has a greater length 11 compared to a length 12 of the first section 46, the lengths 11, 12 being measured along the longitudinal channel axes L and as lengths projected onto a surface plane or a plane parallel thereto. In the example shown in FIG. 4, such a plane runs parallel to the direction of flow S and is perpendicular to the sheet plane, as can be seen from the illustrated extensions of the lengths 11, 12. In addition, a height increase of the first section 44 is less pronounced than in the case of the second section 46, i.e. the first section 44 is less steep and/or less inclined. Finally, the first section 44 is curved and concave, whereas the second section 46 is optionally flat. With such a design, the flow of water from the channel 34 can be directed more strongly in the direction of the PTL. As a result, the PTL and the adjacent catalyst layer can be at least partially flushed free of oxygen that accumulates therein, which increases the probability that the water carried in channel 34 will reach the adjacent catalyst layer to an increased extent. In addition, with a comparatively small length 12 of the section 46 compared to 11 and a flat contour of the section 46, i.e. a steep descent of the section 46, it can be achieved that the flow decreases in a controlled manner behind the region with reduced flow cross-section 42 and thus remains energy-efficient. This makes it possible to use shorter reduced flow regions 42, the space requirement is reduced and there are more design options for the active region of the separator plate 18.

FIG. 5 shows an alternative design of a region with a reduced flow cross-section 42 in a view analogous to FIG. 4. In this case, a longer first section 44 arranged upstream of a second section 46 is again provided. However, this is less curved and merges more evenly into a region with a reduced flow cross-section 42. The same advantages as in the case of FIG. 4 can be achieved and the same length ratios result, even if the lengths 11, 12 are not shown separately in FIG. 5.

FIGS. 6-8 each show sectional views of a channel 34 in which the sectional plane is orthogonal to the longitudinal axis L of the channel. Consequently, in these figures, the longitudinal channel axis L, which is not shown separately, and also a flow direction S, are orthogonal to the image plane. The views each contain the view of a channel 34, which is arranged between two webs 36. The channel 34 has a region with a reduced flow cross-section 42, which connects two opposing channel side walls 37.

FIG. 6 shows a variant in which the region with reduced flow cross-section 42 has a convex upper, that is, outer side. This curvature can be formed at least in a highest region of the region with reduced flow cross-section 42, for example in a region to which the reference sign 42 points in FIGS. 4 and 5.

In FIG. 7, however, the corresponding outer, that is, upper side is flat.

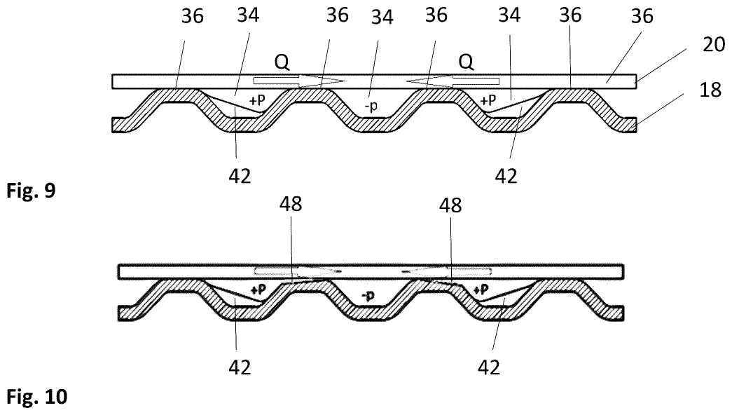

In FIG. 8, the outer, that is, upper side is inclined. The region with the reduced flow cross-section 42 thus merges into the opposing channel side walls 37 at different height positions. The variant shown in FIG. 8 may favor cross flows, as explained below with reference to FIGS. 9 and 10.

It should be noted that the designs of a reduced flow cross-section region according to FIGS. 4 and 5 can be combined with any variant of FIGS. 6-8, but do not have to be. For example, the cross-sectional shape shown in FIG. 4 and/or FIG. 5 can optionally be formed with any of the shapes or orientations of an outer, that is, upper side shown in FIGS. 6-8. This means that the cross-sectional shape from FIG. 4 can optionally be combined with the design from FIG. 6 or FIG. 7 or FIG. 8. The cross-sectional shape from FIG. 5 can optionally also be combined with the design from FIG. 6 or FIG. 7 or FIG. 8.

FIGS. 9 and 10 are partial sectional views through a separator plate 18, the sectional plane being analogous to FIGS. 6-8 and the view comprising a plurality of adjacent webs 36 and channels 34.

In this case, the separator plate 18 is designed, for example, according to the variant shown in FIG. 3B or 3C. Accordingly, two of the illustrated channels 34 have two reduced flow cross-section regions 42 lying in the sectional plane, whereas a further channel 34 positioned between these channels 34 has no reduced flow cross-section region 42 lying in the sectional plane and positioned at a same longitudinal axis position.

The regions with reduced flow cross-section 42 are, for example, inclined, analogous to the variant in FIG. 8. As a result of the reduction in cross-section, the regions with reduced flow cross-section 42 generate a local increase in pressure +P of the water flowing in the channels 34. In comparison, the middle channel 34 shown has a lower pressure −p at the same longitudinal axis position. This creates a differential pressure between the channels 34. This favors cross flows Q between the channels, which run transverse to the longitudinal axes of the channels and flow over webs 36 positioned between the channels 34, at least in sections. As shown, these cross flows Q can penetrate the PTL and pass through it. As a result, the PTL can be at least partially flushed free of oxygen that accumulates in it, which increases the probability that the water carried in the channels will reach a catalyst layer (not shown in this figure) to an increased extent.

FIG. 10 is a view analogous to FIG. 9, but in which channel-connecting regions 48 are also indicated. These favor a fluid connection between the adjacent channels 34 across the webs 36. For example, as shown, they lower the height level of the webs 36 at least in sections, which favors overflowing of the water.

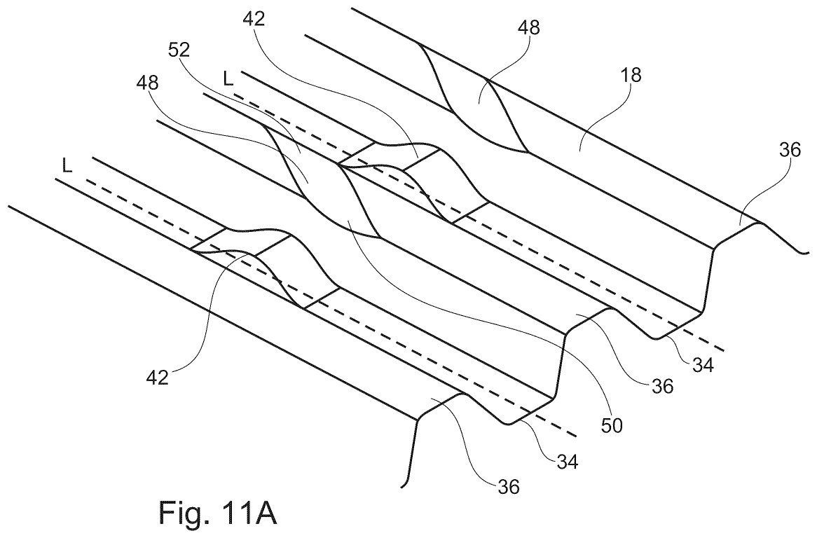

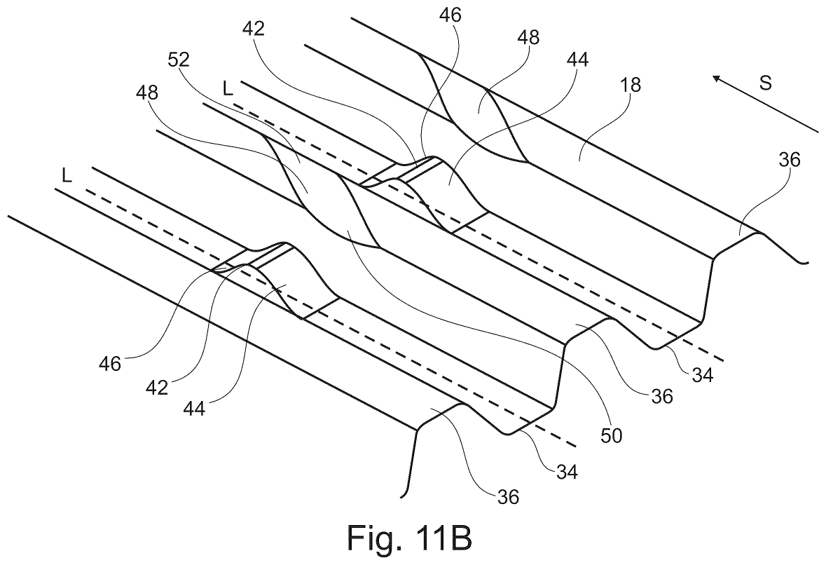

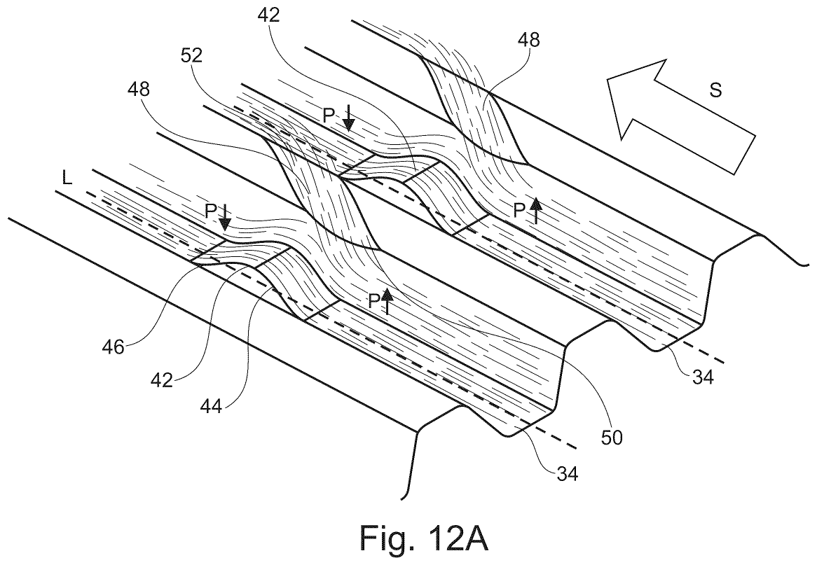

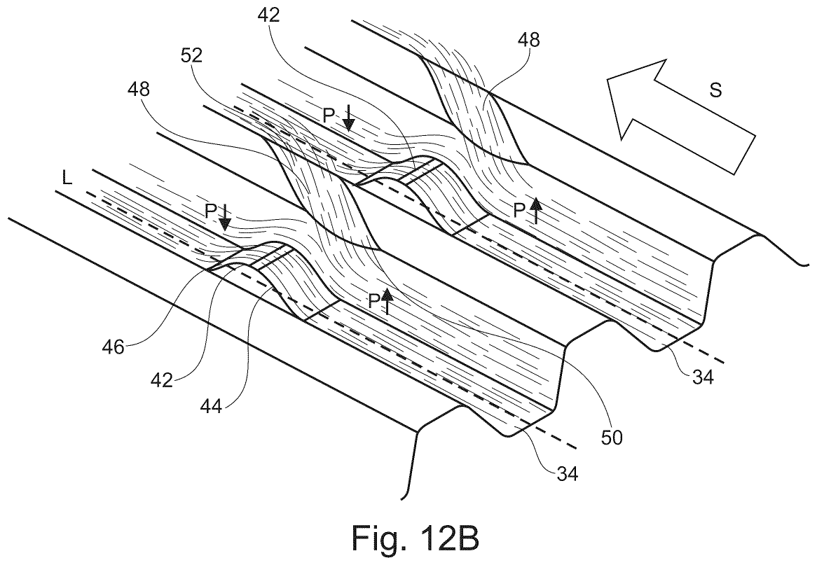

FIGS. 11A and 12A show partial perspective views of a separator plate 18. An exemplary pair of adjacent channels 34 is shown, which are separated from each other by a web 36. As an example, the channels 34 each have regions with reduced flow cross-sections 42, which are arranged purely optionally at essentially identical positions along the respective longitudinal axes L of the channels. Viewed in the transverse direction to the longitudinal channel axes L, channel-connecting regions 48 are arranged adjacent to the regions with reduced flow cross-section 42. The channel-connecting regions 48 are located, for example, at the same positions along the longitudinal axes L as the regions with reduced flow cross-section 42.

For one of the channel-connecting regions 48, a first mouth region 50 is also shown, which opens into a first channel 34, as well as a second mouth region 52, which opens into the second channel 34 adjacent thereto.

FIG. 12A shows the partial section of the separator plate 18 from FIG. 11A in a flow-guiding state. It can be seen that the regions with reduced flow cross-section 42, viewed in flow direction S, again have an upstream first section 44 and a downstream second section 46. These sections 44, 46 may, for example, be formed according to any of the variants explained herein. At the upstream first section 44, as indicated by corresponding reference signs and arrows, a local pressure increase of the water conducted in a respective channel 34 takes place. At the second section 46 downstream in the direction of flow S, however, there is a local pressure drop compared to the pressure at the upstream first section 44.

In the example shown, the channel-connecting regions 48 are formed in such a way that the first mouth region 50 is located close to the first section 44 of the correspondingly adjacent region 42 with reduced flow cross-section 42 of the first channel 34 and at least in sections along a same region of the longitudinal axis 34 of the channel. The second mouth region 52, on the other hand, is positioned adjacent to and in a same longitudinal axis section as the second section 46 of the reduced flow cross-section region 42 of the neighboring second channel 34. Thus, the channel-connecting region 48 connects regions within the channels 34 that have different pressures, and for example an upstream region with increased pressure to a downstream region with reduced pressure. This favors cross flows between the adjacent channels 34. These cross flows are also oriented at least partially in the flow direction S, which further reduces turbulence.

FIGS. 11B and 12B show largely identical variants of FIGS. 11A and 12A, but with a length ratio 11 to 12 of the first and second sections 44, 46 comparable to FIGS. 4 & 5. In other words, these figures illustrate a previously described and optionally provided abrupt descent of the second section 46.

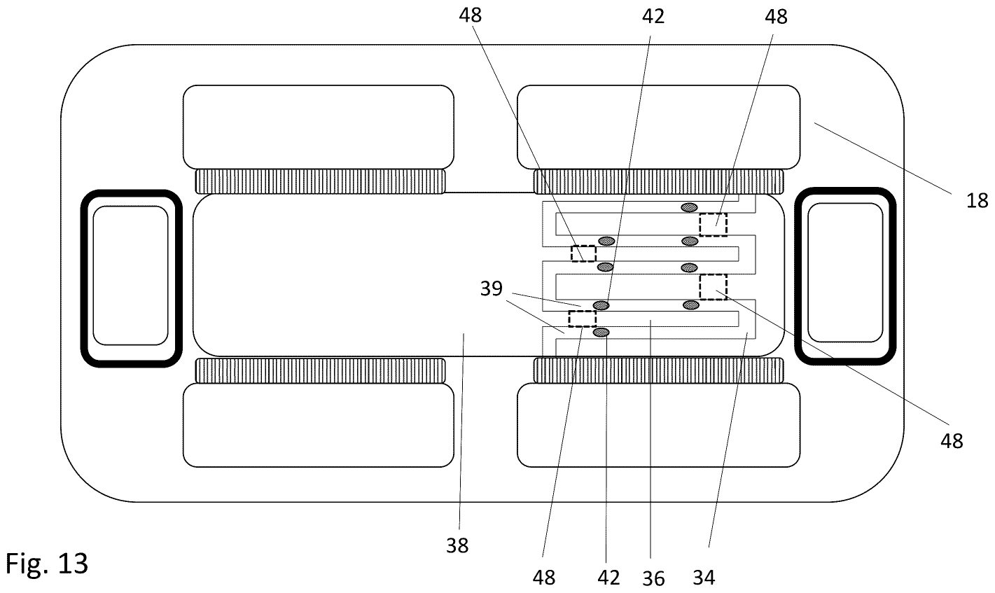

FIG. 13 shows a separator plate 18 in a view comparable to FIG. 2. This separator plate 18 differs from the variant shown in FIG. 2 with regard to a channel course in the flow field 38. In the following, only this difference will be discussed and all further comments on FIG. 2 also apply accordingly to the variant in FIG. 13.

In FIG. 13, the channels 34 in the flow field 38 have a multiply-angled and thus meandering course. A longitudinal axis of the channel, which is not shown, also runs at multiple angles and in a meandering shape. A selected channel 34 is shown in FIG. 13, wherein the proportions are schematically exaggerated and not representative. It is understood that a plurality of channels 34 formed in this way is provided in the flow field 38. It is further understood that adjacent channels 34 are in turn separated from one another by means of webs 36. Due to the meandering shape of the channels 34, the webs 36 also extend, at least in sections, between two channel sections 39 that are adjacent to one another and run parallel to one another, at least in sections. Two such channel sections 39 are marked in FIG. 13 as examples with a corresponding reference symbol.

The channels 34 in turn each have a plurality of regions with reduced flow cross-section 42, which are schematically indicated in the form of dots and of which only selected ones are provided with a corresponding reference sign. Furthermore, the webs 34 each have channel-connecting regions 48, which in this case, however—as an alternative or in addition to mutually adjacent channels 34—connect mutually adjacent channel sections 39 to one another. Once again, these channel-connecting regions 48 may be arranged close to or immediately adjacent to regions with reduced flow cross-sections 42, in order to convert pressure increases generated there into cross-flows between the connected channel sections 39.

1. A separator plate for an electrochemical system,
wherein the separator plate has, at least on a first side, a plurality of channels through which flow can pass in a longitudinal direction of the channel and which are each separated from one another, at least in sections, by a web,
wherein the channels each have a plurality of regions with reduced flow cross-section, and
wherein a number of regions with reduced flow cross-section within a first half of a total channel length of each channel is less than within a second half of the total channel length.

2. The separator plate according to claim 1, where the first half is upstream of the second half.

3. The separator plate according to claim 1, wherein the number of regions with reduced flow cross-section within the second half of the total channel length is at least 10% higher than within the first half of the total channel length.

4. The separator plate according to claim 1, wherein the number of regions with reduced flow cross-section within the first half and/or the second half of the total channel length is at least 5.

5. The separator plate according to claim 1, wherein at least within the second half of the total channel length, a separation distance between successive regions with reduced flow cross-section is inhomogeneous.

6. The separator plate according to claim 5, wherein at least in sections, the separation distance decreases with respect to the longitudinal direction of the channel.

7. The separator plate according to claim 1, wherein at least some positions, with respect to the total channel length, of the regions with reduced flow cross-section of a respective channel deviate from positions of the regions with reduced flow cross-section of at least one other channel of the plurality of channels.

8. The separator plate according to claim 7, wherein the at least one other channel is an immediately adjacent channel.

9. The separator plate according to claim 1, wherein the regions with reduced flow cross-section define a flow cross-section reduction primarily in a height direction of a respective channel.

10. The separator plate according to claim 1, wherein the regions with reduced flow cross-section have a first section with increasing height and a second section with decreasing height with respect to the longitudinal direction of the channel, wherein the first section is located upstream of the second section and has a greater length than the second section.

11. The separator plate according to claim 1, wherein at least some of the regions with reduced flow cross-section extend between a first channel side wall and a second channel side wall and rise, at least in sections, towards one of the first and second channel side walls.

12. The separator plate according to claim 1, wherein at least some of the webs have at least one channel-connecting region.

13. The separator plate according to claim 12, wherein the at least one channel-connecting region has a first mouth region which opens into a first of the channels or channel sections separated by the web, and a second mouth region which opens into a second of the channels or channel sections separated by the web.

14. The separator plate according to claim 13, wherein the first and second mouth regions are at different heights.

15. The separator plate according to claim 1,
comprising or consisting of titanium; and/or
having a material thickness of at least 0.2 mm; and/or
having, on both sides of a flow field that comprises at least sections of the channels, a plurality of through-openings, which are each connected to the flow field in a fluid-conducting manner.

16. A separator plate for an electrochemical system,
wherein the separator plate has, at least on a first side, a plurality of channels through which flow can pass in a longitudinal direction of the channel and which are each separated from one another by a web,
wherein the channels each have a plurality of regions with reduced flow cross-section,
wherein the regions with reduced flow cross-section have a first section with increasing height and a second section with decreasing height, and
wherein the first section is located upstream of the second section and has a greater length than the second section.

17. A separator plate for an electrochemical system,
wherein the separator plate has, at least on a first side, a plurality of channels through which flow can pass in a longitudinal direction of the channel and which are each separated from one another by a web,
wherein the channels each have a plurality of regions with reduced flow cross-section, and
wherein at least some of the regions with reduced flow cross-section extend between a first channel side wall and a second channel side wall and rise, at least in sections, towards one of the first and second channel side walls.

18. A separator plate for an electrolyzer,
wherein the separator plate has, on at least a first side, a plurality of channels through which flow can pass in a longitudinal direction of the channel and which are each separated from one another by a web,
wherein the channels each have a plurality of regions with reduced flow cross-section, and
wherein at least some of the webs have at least one channel-connecting region and the at least one channel-connecting region has a first mouth region in which it opens into a first of the channels separated by the web, and a second mouth region in which it opens into a second of the channels separated by the web.

19. An electrochemical system comprising a plurality of separator plates according to claim 1.

20. The electrochemical system according to claim 19, wherein a respective separator plate is installed in a single layer.
